(19) United States
(12) Patent Application Publication
(10) Pub. No.: US 2012/0293775 A1
(43) Pub. Date: Nov. 22, 2012

(54) SCANNING TYPE PROJECTOR

(76) Inventors: Hiromi KITA, Hiratsuka (JP); Kunikazu Ohnishi, Yokosuka (JP)

(21) Appl. No.: 13/473,713

(22) Filed: May 17, 2012

(30) Foreign Application Priority Data
May 20, 2011 (JP) 2011-113026

(51) Int. Cl. G03B 21/14

(52) U.S. Cl. 353/38

(57) ABSTRACT

A scanning type projector for scanning an optical beam emitted from a laser light source has a collimator lens and a scanning device. A beam demagnifying and shaping prism is disposed between the collimator lens and the scanning device. The cross section of the beam that is elliptical is demagnified along the major axis of the ellipse such that the cross section of the beam is shaped. Thus, the cross section of the beam fits within the effective diameter of a deflecting mirror incorporated in the scanning device. The optical beam is reflected efficiently. A bright image can be projected. The resolution is improved by the beam shaping effect.

### INCORPORATION BY REFERENCE

The present application claims priority from Japanese application JP2011-113026 filed on May 20, 2011, the content of which is hereby incorporated by reference into this application.

### BACKGROUND OF THE INVENTION

The present invention relates to a scanning type projector.

For example, Patent Document 1 (JP-A-2010-32797) is available as an item of background art relevant to the present invention and says that an optical scanning type projector is offered which can display wide-field-angle images at high resolution and high image quality even in a narrow space irrespective of the use environment although the projector is small.

### SUMMARY OF THE INVENTION

In recent years, a scanning type projector has been realized which causes an optical beam emitted from a semiconductor laser source to be scanned in two dimensions on a screen and which displays an image. This scanning type projector is anticipated as a next-generation display device because a color reproduction range can be made wider than the prior art projector since the laser light source is used and because the size can be reduced.

In order to project a bright image from a scanning type projector, the energy of an optical beam must be emitted from the enclosure at a maximum efficiency.

In the case of the scanning type projector, a single optical spot formed on the screen by a single optical beam corresponds to one pixel. In order to bring the resolution in the up-and-down direction of the image into agreement with the resolution in the left-and-right direction, the optical spot on the screen is preferably circular in shape. On the other hand, far-field pattern (hereinafter may be abbreviated FFP) light intensity distribution of an optical beam emitted from the semiconductor laser is elliptical and so the optical spot on the screen is also elliptical. Therefore, there is the problem that the resolution in the vertical direction of the image is different from the resolution in the horizontal direction.

In view of this problem, Patent Document 1 proposes an optical system in which the optical spot dimension taken along the minor axis of the aforementioned elliptical FFP is increased by the use of two prisms to thereby make the FFP substantially circular, whereby bringing the resolution in the vertical direction of the image into agreement with the resolution in the horizontal direction. However, if the spot dimension of the optical beam taken along the minor axis is increased, the energy density of the optical beam decreases, deteriorating the efficiency. This leaves the problem that it is impossible to project a bright image.

The present invention is intended to provide a scanning type projector which is simple in structure and capable of projecting a bright and high-resolution image.

The above-described object is achieved by the configurations set forth in the claims.

The present invention can provide a scanning type projector which is simple in structure and can project a bright and high-resolution image.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram of a scanning type projector 100 of embodiment 1, showing the configuration of the projector.

FIG. 2 is an explanatory view of a beam demagnifying and shaping prism 107 of embodiment 1.

FIG. 3 is a cross-sectional view of an optical beam on a deflecting mirror 120 in a case where the beam demagnifying and shaping prism 107 of embodiment 1 is not installed.

FIG. 4 is a cross-sectional view of an optical beam on the deflecting mirror 120 in a case where the beam shaping prism of Patent Document 1 is installed.

FIG. 5 is a cross-sectional view of an optical beam on the deflecting mirror 120 after passage through the beam demagnifying and shaping prism 107 of embodiment 1.

FIG. 6 is a diagram of a scanning type projector 200 of embodiment 1, showing the configuration of the projector.

FIG. 7 is a diagram of a scanning type projector 300 of embodiment 1, showing the configuration of the projector.

FIG. 8 is a diagram of a scanning type projector 400 of embodiment 2, showing the configuration of the projector.

FIG. 9 is a diagram of a scanning type projector 500 of embodiment 3, showing the configuration of the projector.

FIG. 10 is a diagram of a scanning type projector 600 of embodiment 4, showing the configuration of the projector.

### DETAILED DESCRIPTION OF THE INVENTION

Although the invention is hereinafter described in detail based on embodiments shown in the drawings, the invention is not restricted thereby.

### Embodiment 1

Embodiment 1 of the present invention is described with reference to figures.

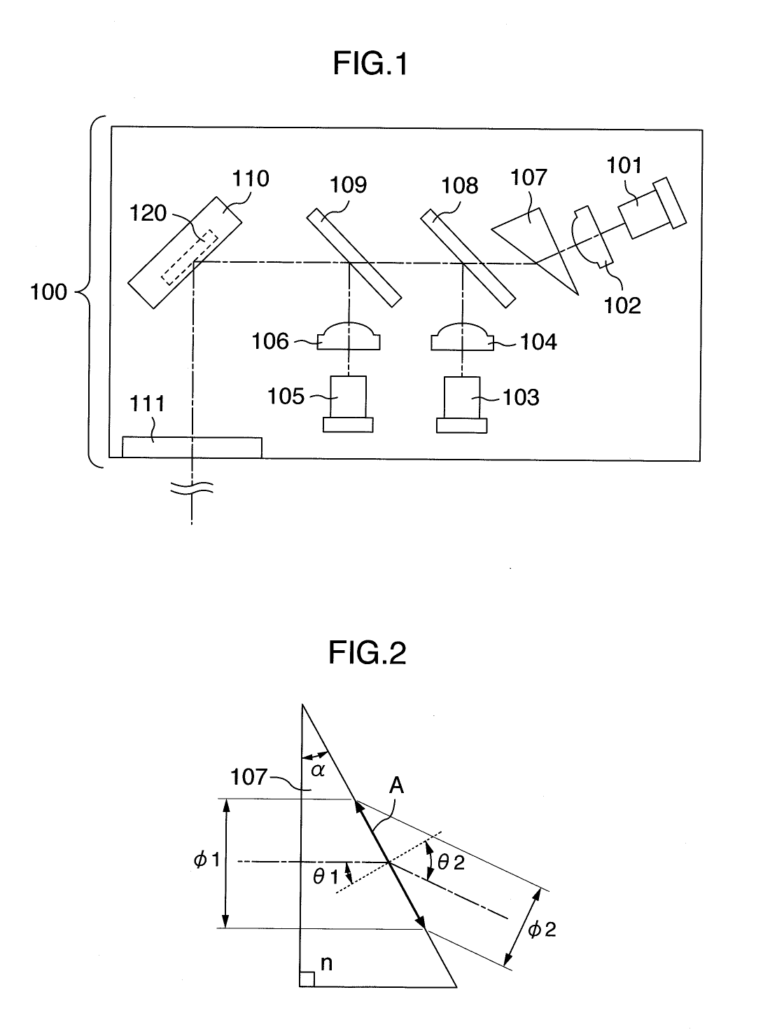

FIG. 1 shows a scanning type projector, 100, of embodiment 1 of the present invention. The dot-and-dash line indicates the optical axis of optical beams.

A laser light source 101 is a semiconductor laser emitting a green light beam, for example, in the 520 nm band. The green light beam emitted from the laser light source 101 is converted into a parallel light beam or a slightly converged light beam by a collimator lens 102.

Then, the green light beam impinges on a beam demagnifying and shaping prism 107. Since it is assumed that the laser light source 101 is a semiconductor laser, the FFP of the light beam emitted from the semiconductor laser takes an elliptical form. Therefore, the cross section of the green light beam impinging on the beam demagnifying and shaping prism 107 is also elliptical in shape. It is now assumed that the laser light source 101 is rotationally adjusted such that the direction of the major axis of the elliptical form of the FFP is horizontal to the plane of the paper. In the direction of the beam demagnifying and shaping prism 107 which is parallel to the plane of the paper, the incident side of the prism for the green light beam is substantially perpendicular to the beam, while the outgoing side is a tilted surface. On the other hand, in the direction perpendicular to the plane of the paper, the incident side and outgoing side of the prism for the green light beam are substantially perpendicular to the beam. The demagnifying and shaping prism 107 has a function of reducing the cross section of the green light beam only along the major axis to thereby shape the cross section into a substantially circular form. Details of the prisms 107 will be described in detail later.

Another laser light source 103 is a semiconductor laser emitting a red light beam, for example, in the 640 nm band. The red light beam emitted from the laser light source 103 is converted into a parallel light beam or a slightly converted light beam by another collimator lens 104.

A further laser light source 105 is a semiconductor laser emitting a blue light beam, for example, in the 440 nm band. The blue light beam emitted from the laser light source 105 is converted into a collimated light beam or a slightly converted light beam by a further collimator lens 106.

An optical combining device 108 is a wavelength-selective mirror that transmits the green light beam but reflects the red light beam. Furthermore, the combining device is so adjusted that the optical axes of the green and red light beams are substantially coincident.

Another optical combining device 109 is a wavelength-selective mirror having a function of transmitting the green and red light beams but reflects the blue light beam. The device 109 is so adjusted that the optical axes of the blue, green, and red light beams are substantially coincident.

The combined optical beams of the three colors impinge on a scanning device 110, which includes a deflecting mirror 120 and a driver electrode or the like (not shown) for driving the mirror 120. The deflecting mirror 120 has a horizontal scanning axis and a vertical scanning axis. The mirror 120 has a function of scanning the optical beams in two dimensions on a screen by driving the mirror 120 so as to be deflected about each of the scanning axes. The deflecting mirror 120 can be achieved, for example, by using a microelectromechanical systems (MEMS) mirror, a galvano mirror, or the like. The scanning device 110 may be made of two deflecting mirrors, in which case the first deflecting mirror may have a vertical scanning axis, while the second deflecting mirror may have a horizontal scanning axis.

The optical beams of the three colors transmitted through the scanning device 110 enter into a transparent cover 111 mounted on the lower surface of the scanning type projector 100. It is assumed that the cover 111 is made of transparent glass or plastic having a sufficiently high transmittance for the optical beams of the three colors. The cover can prevent dust from entering the scanning type projector 100; otherwise, transmittances of the optical components would deteriorate or the scanning device 110 would break down.

The optical beams of the three colors transmitted through the transparent cover 111 form three optical spots overlapped at the same position on the screen installed outside. That is, they can be noticed as a single optical spot on the screen. In the case of the scanning type projector 100 of the present embodiment, one optical spot corresponds to one pixel of image.

As described so far, the scanning type projector 100 of the present embodiment may be configured including at least the laser light source 101, collimator lens 102, laser light source 103, collimator lens 104, laser light source 105, collimator lens 106, beam demagnifying and shaping prism 107, optical combining devices 108, 109, scanning device 110, and transparent cover 111. An additional optical device such as a diffraction grating or wave plate may be placed in an intermediate position or the optical path may be bent with at least one mirror. Additionally, an optical device having a function of converting the scanning angle of the scanning device 110 may be added to the optical path between the transparent cover 111 and the scanning device 110.

Then, details of the beam demagnifying and shaping prism 107 are described by referring to FIG. 2.

FIG. 2 illustrates the beam demagnifying and shaping prism 107. The dot-and-dash line indicates the optical axis of each optical beam. The optical beam travels to the right in the plane of the paper. φ1 and φ2 indicate optical flux diameters of the cross sections of the optical beam taken in a direction perpendicular to the plane of the paper. An optical flux diameter is so defined that the ratio of the light intensity of the optical beam at a position spaced from the optical axis by the optical flux diameter to the light intensity of the beam on the optical axis is 1/exp(2).

In a direction horizontal to the paper of the paper, the beam demagnifying and shaping prism 107 has an incident surface substantially perpendicular to the direction of travel of the optical beam and an outgoing surface tilted with respect to the direction of travel of the optical beam. On the other hand, in a direction perpendicular to the plane of the paper, the prism has an incident surface and an outgoing surface which are substantially perpendicular to the optical beam.

As described previously, the FFP, i.e., cross-sectional shape, of the optical beam exiting from the laser light source 101 is elliptical. It is assumed that a rotational adjustment is so made that the direction of the major axis of the FFP of the optical beam is parallel to the plane of the paper.

When the optical beam enters into the beam demagnifying and shaping prism 107, the incident side of the prism is substantially perpendicular to the beam and so the components of the cross section of the beam along the major axis travel straight intact. However, when the beam exits from the prism 107, the outgoing side is tilted relative to the optical beam. Therefore, the beam is refracted. At this time, the optical flux diameter of the beam is reduced as shown.

On the other hand, in the direction of the minor axis of the cross section of the optical beam, the incident and outgoing sides are substantially perpendicular to the optical beam and, therefore, the beam is not refracted but exits intact. Consequently, the optical beam passes as it is without the optical flux diameter along the minor axis of the beam cross section decreasing.

In this way, the beam demagnifying and shaping prism 107 transmits the beam such that the dimension of the cross section taken along the major axis of the cross section of the beam is reduced but the dimension of the cross section taken along the minor axis is not altered. Consequently, the prism converts the cross-sectional shape of the optical beam from the elliptical form into a substantially circular form.

A method of designing the shown apex angle α of the beam demagnifying and shaping prism 107 is hereinafter described.

Let n be the refractive index of the beam demagnifying and shaping prism 107. Let θ1 be the angle between the normal line (indicated by the dotted line) to the outgoing surface of the prism 107 and the optical beam entering into the outgoing surface. Let θ2 be the angle between the normal line and the optical beam going from the outgoing surface. Let A be the optical flux diameter of the cross section of the optical beam taken along the outgoing surface of the prism 107. The following equations are obtained:

$$\begin{matrix}sin θ 1 = \sqrt{1 - {( φ 1 / A )}^{2}} & ( 1 ) \\ sin θ 2 = \sqrt{1 - {( φ 2 / A )}^{2}} & ( 2 )\end{matrix}$$

Furthermore, from the Snell's law, the relation of Eq. (3) is well known.

n·sin θ1=sin θ2 (3)

Substituting Eqs. (1) and (2) into Eq. (3) determines the angle θ1.

$$θ 1 = {sin}^{- 1} \sqrt{\frac{φ {1}^{2} - φ {2}^{2}}{{n}^{2} \cdot φ {1}^{2} - φ {2}^{2}}} \qquad ( 4 )$$

It can be seen from the figure that the apex angle α is equal to the angle θ1. Therefore, the apex angle α can be found from Eq. (4).

$$α = θ 1 = {sin}^{- 1} \sqrt{\frac{φ {1}^{2} - φ {2}^{2}}{{n}^{2} φ {1}^{2} - φ {2}^{2}}} \qquad ( 5 )$$

In a case where the material of the beam demagnifying and shaping prism 107 is BK7, the wavelength of the optical beam is 520 nm, and the optical flux diameter is reduced from φ1=1.5 mm to φ2=1.0 mm, the apex angle α=33° is computed from Eq. (5).

The advantageous effects of the beam demagnifying and shaping prism 107 are next described.

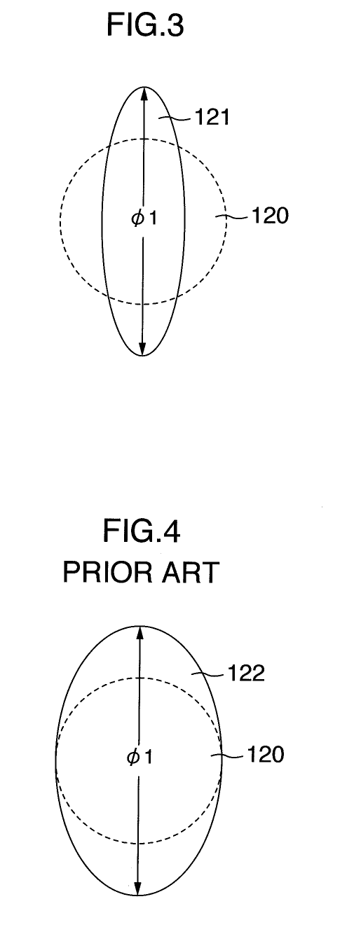

FIG. 3 schematically illustrates the cross section 121 of the optical beam on the deflecting mirror 120 in a case where the beam demagnifying and shaping prism 107 is not disposed, the cross section 121 being defined by optical flux diameter φ1. The circle indicated by the broken line indicates the effective diameter of the mirror 120. Usually, a deflecting mirror has a roughly circular effective diameter. Where the prism 107 is not disposed, the cross section 121 of the optical beam is elliptical. The length of the cross section taken along the major axis corresponds to the optical flux diameter φ1 shown in FIG. 2. If the length of the cross section 121 taken along the major axis is greater than the effective diameter of the deflecting mirror 120, the energy of the area of the cross section of the optical beam not reflected by the mirror 120 is lost, resulting in a decrease in the efficiency. That is, the brightness of the projected image drops. Furthermore, as shown, the region of the optical beam reflected on the deflecting mirror 120 is elliptical. Consequently, the optical spot formed on the screen is also elliptical. The resolution in the horizontal direction of the screen does not agree with the resolution in the vertical direction. Either resolution deteriorates.

FIG. 4 illustrates the cross section 122 of the optical beam on the deflecting mirror 120 that is defined by optical flux diameter φ1 in a case where the beam shaping prism of Patent Document 1 is installed. This conventional beam shaping beam acts to enlarge the cross section only along the minor axis. Consequently, the optical spot can be brought close to a circular form. As a result, the resolution is improved. However, outer portions of the cross section of the beam as viewed along the major axis are located outside the effective region of the deflecting mirror 120 and so the energy is lost. The efficiency is kept deteriorated. Hence, it is impossible to project a bright image.

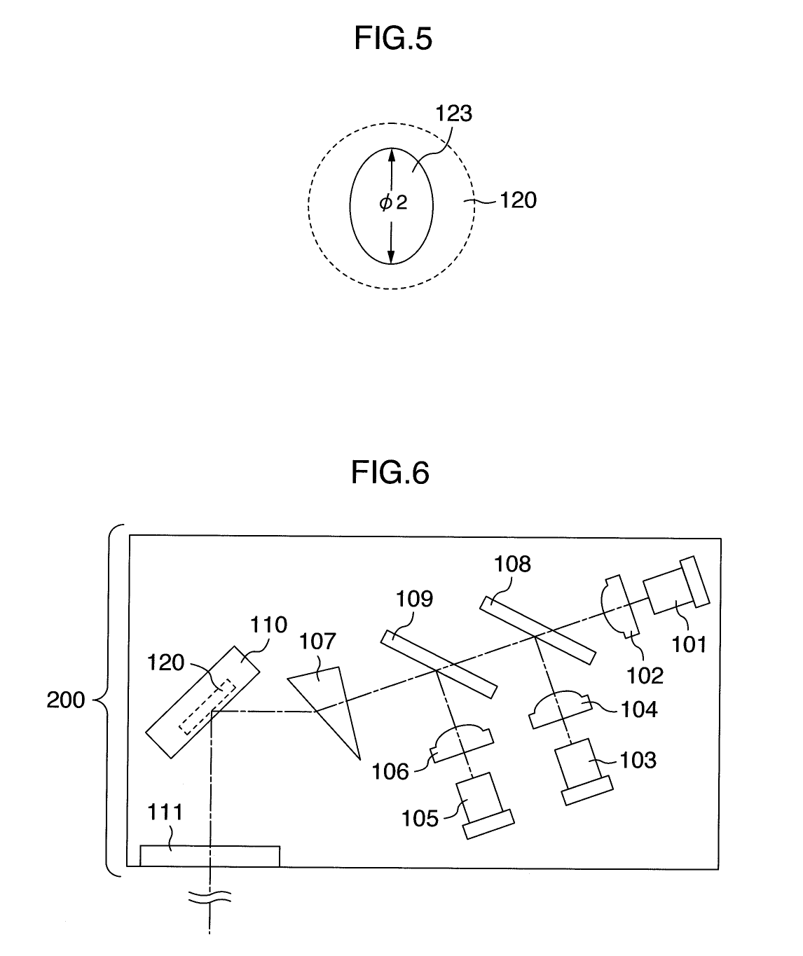

FIG. 5 schematically illustrates a cross section 123 of an optical beam on the deflecting mirror 120 in a case where the beam demagnifying and shaping prism 107 of the present invention is installed. The dimension of the cross section 123 taken along the major axis is reduced to optical flux diameter φ2 by the prism 107. Since all the incident optical flux is within the effective diameter of the deflecting mirror 120, the optical beam can be reflected almost totally by the deflecting mirror. Hence, the beam can be made to go from the enclosure efficiently. That is, a bright image can be projected. Furthermore, the cross section of the beam can be made substantially circular by placing the beam demagnifying and shaping prism 107. In consequence, the spot on the screen is substantially circular. The resolution in the left-and-right direction of the screen is nearly coincident with the resolution in the up-and-down direction. Thus, the resolution can be improved.

Where the beam demagnifying and shaping prism 107 is arranged in this way, a bright image can be projected. Additionally, this creates the advantage that the resolution can be improved.

It is assumed that the beam demagnifying and shaping prism 107 is so shaped that the incident surface is substantially perpendicular to the optical beam and that the outgoing surface is at an angle to the optical beam. The invention is not restricted to a prism of such a shape. For example, the incident and outgoing surfaces may be tilted relative to the optical beam.

The visibility of the human eye is most sensitive to green light and so the brightness and resolution of the light spot formed on the screen by the green light beam most affects the image quality. Therefore, in the present embodiment, a configuration is assumed in which only the beam demagnifying and shaping prism 107 for improving the efficiency and resolution of the green light beam is arranged between the collimator lens 102 and the optical combining device 108. This prevents an increase in the parts count. This also produces the advantage that the parts cost can be reduced. However, it is also possible to arrange a beam demagnifying and shaping prism for enhancing the efficiency and resolution of a red light beam or blue light beam either between the collimator lens 104 and the optical combining device 108 or between the collimator lens 106 and the optical combining device 109.

Furthermore, the beam demagnifying and shaping prism 107 may be disposed between the optical combining device 109 and scanning device 110 as in a scanning type projector 200 shown in FIG. 6. In this case, three optical beams can be demagnified and shaped in cross section with the single beam demagnifying and shaping prism. However, because of the chromatic aberration in the beam demagnifying and shaping prism, the refraction angle is different for the green, red, and blue light beams. Therefore, the optical beams of the three colors leaving the beam demagnifying and shaping prism are different in angle. In this case, the angles of the optical combining devices 108 and 109 or the positions of the laser light sources and of the collimator lenses may be adjusted such that the optical beams of the three colors exiting from the prism are coincident in angle.

In the present embodiment, the optical axes of the optical beams of the three colors (green, red, and blue) are synthesized by the optical combining devices 108 and 109 that are wavelength-selective mirrors. However, in a scanning type projector as in the present embodiment, the projector may be so configured that optical beams of three colors synthesize the optical axes. Instead of two wavelength-selective mirrors, two wavelength-selective prisms may be used. Furthermore, green, red, and blue laser light sources may be arranged differently. In addition, a single wavelength-selective cross prism generally used in a liquid-crystal projector or the like may also be used.

It is also assumed that the three collimator lenses 102, 104, and 106 are used. The projector may also be configured using a single microlens array.

In addition, it is assumed that the laser light sources emitting the green, red, and blue optical beams, respectively, are in separate packages. The light sources may be mounted in a single package.

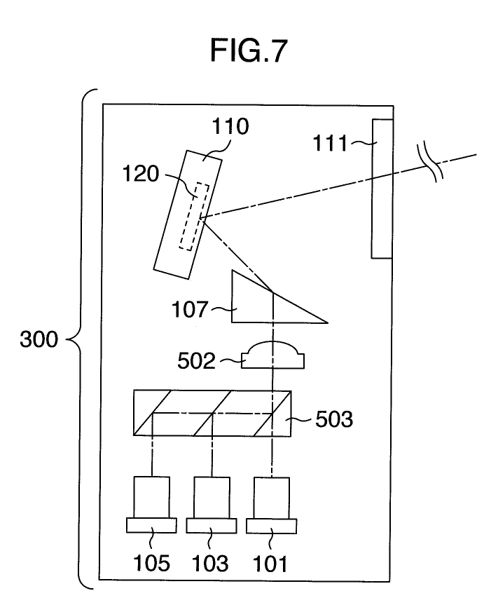

The present embodiment is so configured that after the optical beams of the three colors are converted into parallel rays of light using the three collimator lenses, optical beams of three colors are synthesized by using two optical combining devices. However, after optical beams of three colors are synthesized by an optical combining device 503, the beams may be converted into parallel beams of light by a single collimator lens 502 as in a scanning type projector 300 shown in FIG. 7. Also, in this case, a beam demagnifying and shaping prism may be located immediately behind the collimator lens, and the laser light sources may be so adjusted that the optical beams of the three colors passed through the prism are made coincident in angle.

As described so far, the scanning type projector 110 of the present embodiment is a scanning type projector that makes substantially circular the cross-sectional shape of the optical beam by the use of the beam demagnifying and shaping prism 107 and can improve the resolution, as well as the efficiency.

### Embodiment 2

Then, embodiment 2 of the present invention is described with reference to a figure.

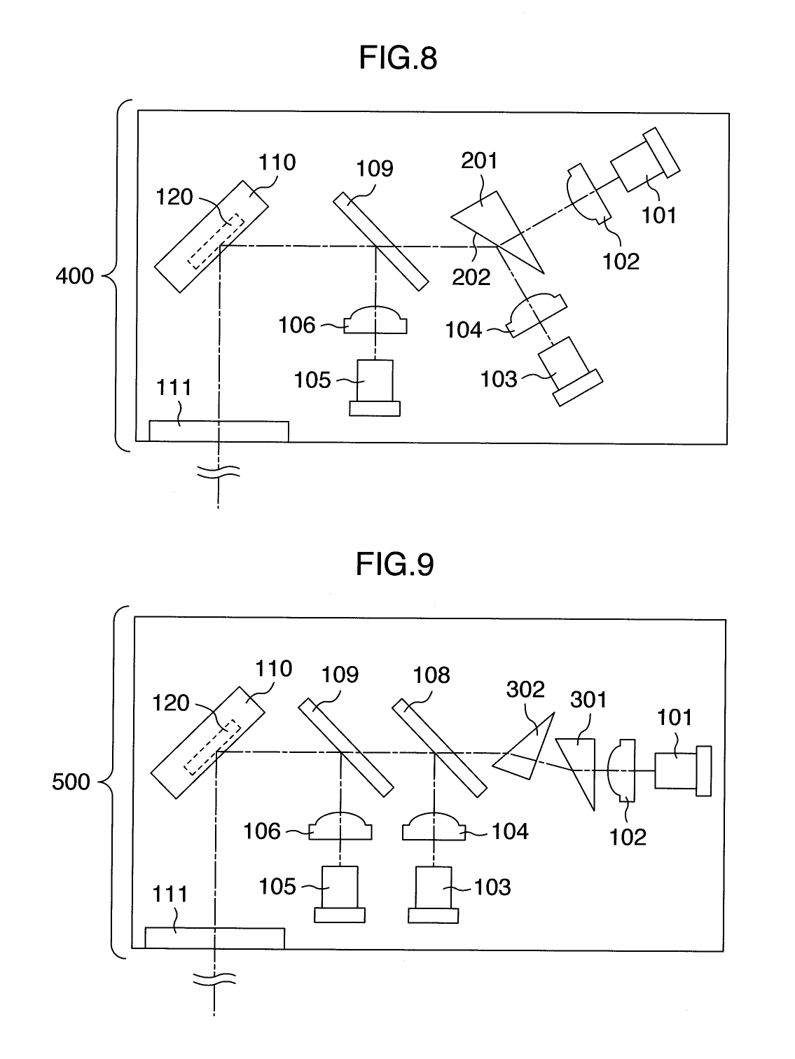

FIG. 8 illustrates a scanning type projector, 400, of embodiment 2.

The scanning type projector 400 is similar to the scanning type projector 100 of embodiment 1 except that the beam demagnifying and shaping prism 107 and optical combining device 108 of the projector 100 are replaced by a beam demagnifying and shaping prism 201.

The other optical parts are the same as their counterparts of the scanning type projector 100 and indicated by the same reference numerals as in the description of embodiment 1. Detailed description of these parts is omitted.

The beam demagnifying and shaping prism 201 is identical in shape with the beam demagnifying and shaping prism 107 of the scanning type projector 100. A wavelength-selective reflective film that transmits the green light beam but reflects the red light beam is formed on an oblique surface 202 that is an outgoing surface for the green light beam emitted from the laser light source 101.

When the green light beam emitted from the laser light source 101 enters into the beam demagnifying and shaping prism 201, the beam passes through the prism 201 while the dimension of the cross section of the green light beam taken along the major axis is reduced.

As also shown in FIG. 8, the red light beam emitted from the laser light source 103 is reflected by the oblique surface 202 of the beam demagnifying and shaping prism 201 and combined with the green light beam.

That is, the beam demagnifying and shaping prism 201 has both the function of the beam demagnifying and shaping prism 107 and the function of the optical combining device 108 of the scanning type projector 100.

The positions of the laser light sources 101, 103 and of the collimator lenses 102, 104 are so adjusted that the blue, green, and red light beams passed through the optical combining device 109 are all coincident with each other as shown. Accordingly, one optical beam synthesized from the three colors enters the scanning device 110. The scanning device 110 scans the single optical beam on the screen.

By installing the beam demagnifying and shaping prism 201 instead of the beam demagnifying and shaping prism 107 and the optical combining device 108, the function of improving the efficiency and the resolution of the green light beam is imparted. Also, the parts count can be reduced.

### Embodiment 3

Subsequently, embodiment 3 of the present invention is described by referring to a figure.

FIG. 9 illustrates a scanning type projector, 500, of embodiment 3.

The scanning type projector 500 is similar to the scanning type projector 100 of embodiment 1 except that the beam demagnifying and shaping prism 107 of the projector 100 is replaced by beam demagnifying and shaping prisms 301 and 302. The other parts are identical with their counterparts of the scanning type projector 100 and indicated by the same numerals as in the description of embodiment 1. Detailed description of these parts is omitted.

In a direction parallel to the plane of the paper, the incident surfaces of the beam demagnifying and shaping prisms 301 and 302 are substantially perpendicular to the direction of travel of the optical beam, and the outgoing surfaces are tilted surfaces. In a direction perpendicular to the plane of the paper, the incident and outgoing surfaces of the prisms are substantially perpendicular to the direction of travel of the optical beam.

As described previously, it is assumed that the laser light source 101 is a semiconductor laser and so the cross section of the exiting optical beam is elliptical. It is assumed that the laser light source 101 is rotationally adjusted such that the direction of the major axis of the ellipse is parallel to the plane of the paper.

Accordingly, when the optical beam passes through the beam demagnifying and shaping prisms 301 and 302, the components of the cross section of the beam located along the minor axis pass through the prisms intact but the dimension of the cross section of the beam located along the major axis is shrunk by the refracting effect of the prisms. Consequently, the cross-sectional shape of the optical beam can be made close to a circular form.

That is, the function of the beam demagnifying and shaping prism 107 of embodiment 1 is distributed to the two beam demagnifying and shaping prisms 301 and 302.

In the present embodiment, the use of the two beam demagnifying and shaping prisms 301 and 302 makes it possible to bring the angle of the optical axis of the optical beam behind the prisms into agreement with the angle of the optical axis of the beam ahead of the prisms. Hence, optical parts can be arranged more easily.

Furthermore, the use of the two beam demagnifying and shaping prisms creates the advantage that the optical flux diameter of the optical beam can be made smaller than the case where only one beam demagnifying and shaping prism is used.

In the present embodiment, a wavelength-selective reflective film that transmits the green light beam but reflects the red light beam may be formed on the outgoing surface of the beam demagnifying and shaping prism 302 instead of the optical combining device 108 in the same way as in embodiment 2. In this case, the laser light source 103 and collimator lens 104 may be rotated in unison about the optical axis passing through the wavelength-selective reflective film such that the optical axis of the green light beam is coincident with the optical axis of the red light beam.

### Embodiment 4

Embodiment 4 of the present invention is next described with reference to a figure.

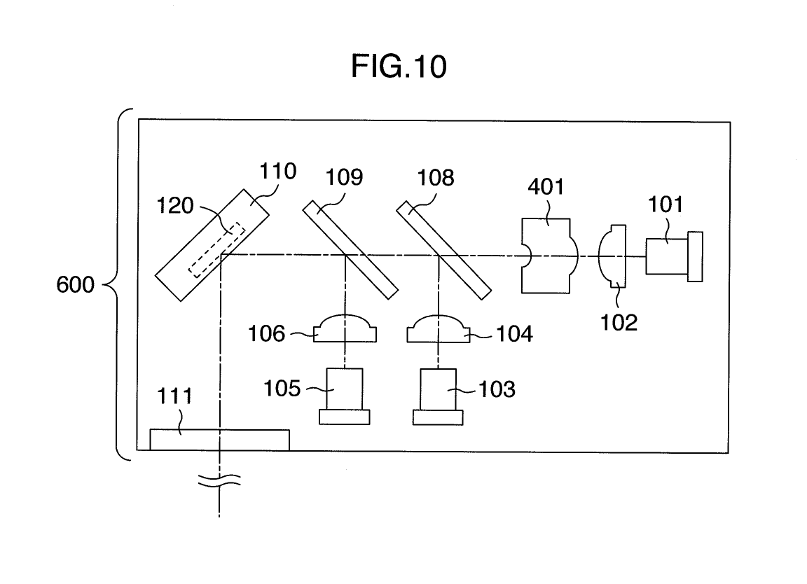

FIG. 10 is a block diagram of a scanning type projector, 600, of embodiment 4.

The scanning type projector 600 is similar to the scanning type projector 100 of embodiment 1 except that the beam demagnifying and shaping prism 107 of the projector 100 is replaced by a beam demagnifying and shaping anamorphic lens 401. The other parts are identical with their counterparts of the scanning type projector 100 and indicated by the same numerals as in the description of embodiment 1. Detailed description of these parts is omitted.

The incident and outgoing surfaces of the beam demagnifying and shaping anamorphic lens 401 are cylindrical lenticular surfaces. That is, in the direction parallel to the plane of the paper, the incident surface forms a convex surface having a given radius of curvature relative to the direction of travel of the optical beam. The outgoing surface forms a concave surface having a given radius of curvature. On the other hand, in the direction perpendicular to the plane of the paper, the incident and outgoing surfaces are substantially perpendicular to the direction of travel of the optical beam and form a simple transparent flat plate.

The laser light source 101 emits an optical beam having an elliptical cross section in the same way as in the scanning type projector 100. The light source is rotationally adjusted such that the direction of the major axis of the ellipse is substantially coincident with the direction of the plane of the paper. The optical beam is emitted as divergent light by the laser light source 101 and converted into substantially collimated or slightly converged light by the collimator lens 102. The beam demagnifying and shaping anamorphic lens 401 is located immediately behind the collimator 102 as shown. The optical beam that is substantially collimated light enters into the anamorphic lens 401.

When such substantially collimated or slightly converged light beam enters into the beam demagnifying and shaping anamorphic lens 401, with respect to the direction of the major axis of the beam cross section, the beam is first converted into converged light by the convex incident surface. When the beam goes from the outgoing surface, the beam is reconverted into substantially collimated or slightly converged light by the concave outgoing surface. On the other hand, with respect to the direction of the minor axis of the beam cross section, the incident and outgoing surfaces act simply as flat plates for the optical beam and so the beam passes intact. In this way, the beam cross section is shrunk only in the direction of the major axis. The cross section is converted from an elliptical form into a substantially circular form. That is, the beam demagnifying and shaping anamorphic lens 401 is a component having the same function as the function of the beam demagnifying and shaping anamorphic lens 107.

Accordingly, the scanning type projector 400 having the beam demagnifying and shaping anamorphic lens 401 can improve the efficiency of the optical beam and the resolution in the same way as the scanning type projector 100 of embodiment 1.

The beam demagnifying and shaping anamorphic lens 401 and the collimator lens 102 may be integrated into a lens having the function of a collimator and the function of demagnifying and shaping a beam cross section. In this case, the collimator lens has a lens surface contour that exhibits different magnifications for the direction parallel to the plane of the paper and the direction perpendicular to it.

It should be further understood by those skilled in the art that although the foregoing description has been made on embodiments of the invention, the invention is not limited thereto and various changes and modifications may be made without departing from the spirit of the invention and the scope of the appended claims.

1. A scanning type projector for scanning an optical beam on a surface and projecting a two-dimensional image onto the surface, comprising:
at least one laser light source for emitting said optical beam in the form of divergent light;
at least one collimator lens for varying the optical beam into collimated light or converged light;
a scanning device for scanning the optical beam on said surface; and
an optical beam demagnifying and shaping device for demagnifying and shaping a cross section of the optical beam in a given direction of the cross section thereof.

2. The scanning type projector according to claim 1, wherein the cross section of the optical beam assumes an elliptical form before passing through said optical beam demagnifying and shaping device, and wherein said optical beam demagnifying and shaping device demagnifies and shapes the cross section of the optical beam along its major axis.

3. The scanning type projector according to claim 1, wherein said optical beam demagnifying and shaping device is configured including at least one trapezoidal or wedge-shaped prism, and wherein an incident angle for the optical beam at an incident surface of said optical beam demagnifying and shaping device is smaller than an outgoing angle for the optical beam at an outgoing surface.

4. The scanning type projector according to claim 1, wherein said at least one light source is two or more laser light sources emitting two or more optical beams having different wavelengths,
said beam demagnifying and shaping prism has a wavelength-selective reflective film on the outgoing surface of the prism, the reflective film having a function of transmitting a first optical beam having a given wavelength at a given transmittance and reflecting a second optical beam having a wavelength different from the wavelength of the first optical beam at a given reflectance,
said first optical beam is made to enter from a side of the incident surface of the beam demagnifying and shaping prism,
said second optical beam is made to enter from a side of the outgoing surface of the beam demagnifying and shaping prism, and
said first optical beam transmitted through the beam demagnifying and shaping prism and the second optical beam reflected off the beam demagnifying and shaping prism travel in the same optical path.

5. The scanning type projector according to claim 1, wherein said beam demagnifying and shaping prism is configured including at least one anamorphic lens having a first cross section of a given curvature and a second cross section of a different curvature perpendicular to the first cross section,
said optical beam assumes the form of collimated light and enters the beam demagnifying and shaping anamorphic lens, and
said beam demagnifying and shaping anamorphic lens permits the optical beam to pass while the collimated light is maintained.

6. The scanning type projector according to claim 1, wherein said beam demagnifying and shaping anamorphic lens has a cylindrical lenticular incident surface and a cylindrical lenticular outgoing surface,
a convex incident surface having a given radius of curvature and a concave outgoing surface having a given radius of curvature are formed in a first given direction of the cross section of said beam demagnifying and shaping anamorphic lens, and
a flat plate having perpendicular incident and outgoing surfaces is formed in a second given direction perpendicular to the first given direction.

7. The scanning type projector according to claim 1, wherein said collimator lens has a given cross section exhibiting a magnification and a cross section perpendicular to the given cross section exhibiting a different magnification.
